(19) United States
(12) Patent Application Publication
(10) Pub. No.: US 2022/0254196 A1
(43) Pub. Date: Aug. 11, 2022

(54) AUTOMOTIVE DIAGNOSTIC KIOSK HAVING AUTONOMOUS FUNCTIONALITY

(71) Applicant: Innova Electronics Corporation, Irvine, CA (US)

(72) Inventor: Jonathan Tran, Irvine, CA (US)

(21) Appl. No.: 17/170,366

(22) Filed: Feb. 8, 2021

(51) Int. Cl. G07C 5/00; G07C 5/08; G06K 9/00

(52) U.S. Cl. CPC G07C 5/008; G07C 5/0808; G06K 9/0063; G07C 5/0825; G07C 5/085

(57) ABSTRACT

An interactive automotive diagnostic kiosk includes a main housing, a processor in the main housing, and a display screen coupled to the main housing and in operative communication with the processor. The kiosk additionally includes a cable head in operative communication with the processor. The cable head is configured to be plug connectable to a diagnostic port on a vehicle to facilitate data communication therebetween. The kiosk additionally includes a triggering sensor configured to detect at least a vehicle or a user and send a triggering signal to the processor in response to such detection. The processor is configured to autonomously generate a user guidance signal, executable by the display screen, to generate a visual alert on the display screen in response to receipt of the triggering signal.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to an automotive diagnostic kiosk, and more specifically, to an automotive diagnostic kiosk having at least one proximity sensor configured to detect the presence of a user or a vehicle to trigger at least one autonomous function.

### 2. Description of the Related Art

Owning and operating a vehicle over a period of time may require routine maintenance and repair of the vehicle. The maintenance and repair may be the result of a routine checkup (e.g., 30,000 mile service), or the result of the owner noticing an operational symptom (e.g., an unexpected noise) when driving the vehicle. In many instances, the vehicle is taken to a dealership or repair shop to complete the maintenance and repair. Oftentimes, the owner of the vehicle may not have expertise in vehicle diagnostics, and thus, may be required to rely upon the opinions of the mechanic as to what repairs may be needed with the vehicle.

While the mechanic may be correct on most occasions, the opinions of the mechanic may not always be correct. Accordingly, the proposed repairs provided by the mechanic may not resolve the issue, which may lead to additional expenditures of time and money to find and fix the issue. Moreover, until the issue is correctly resolved, the vehicle owner may continue to operate a vehicle that may not be suitable for operation.

An additional resource available to vehicle owners for obtaining vehicle diagnostic information is vehicle diagnostic equipment, such as a scan tool or code reader, which communicates with an onboard vehicle computer to obtain vehicle data. After retrieving the vehicle data, an analysis may be performed on the vehicle data to arrive at a possible diagnostic solution.

Although conventional vehicle diagnostic equipment may provide the average vehicle owner with a powerful resource for obtaining a possible diagnostic solution, certain vehicle owners may be intimated by the operational of such vehicle diagnostic equipment. For instance, vehicle diagnostic equipment oftentimes requires connection to a diagnostic port on the vehicle. Many vehicle owners may not be aware of the location of the vehicle diagnostic port on the vehicle, and thus, may give up on trying to use conventional vehicle diagnostic equipment.

Accordingly, there is a need in the art for vehicle diagnostic equipment that is interactive to provide information to a user during operation of the vehicle diagnostic equipment to facilitate use and operation of the equipment. Various aspects of the present disclosure address this particular need, as will be discussed in more detail below.

### BRIEF SUMMARY

In accordance with one embodiment of the present disclosure, there is provided an interactive automotive diagnostic kiosk comprising a main housing, a processor in the main housing, and a display screen coupled to the main housing and in operative communication with the processor. The kiosk additionally includes a cable head in operative communication with the processor. The cable head is configured to be plug connectable to a diagnostic port on a vehicle to facilitate data communication therebetween. The kiosk additionally includes a triggering sensor configured to detect at least a vehicle or a user and send a triggering signal to the processor in response to such detection. The processor is configured to autonomously generate a user guidance signal, executable by the display screen, to generate a visual alert on the display screen in response to receipt of the triggering signal.

The triggering sensor may be a proximity sensor coupled to the main housing and capable of detecting the presence of the vehicle or the user within a prescribed range relative to the proximity sensor. The proximity sensor may be an infrared sensor. The prescribed range may be less than 25 feet.

The triggering sensor may be a camera coupled to the main housing and capable of capturing an image of the vehicle or the user.

The triggering sensor may be a microphone coupled to the main housing or the cable head and configured to detect an audible sound associated with the vehicle or the user arriving within a prescribed range relative to the microphone.

The kiosk may additionally include a gyroscope coupled to the cable head. The gyroscope may be configured to detect an orientation of the cable head relative to a direction of a gravitational force and send a signal to the processor representative of the detected orientation of the cable head. The processor may be configured to compare the detected orientation of the cable head to an acceptable range of orientations and generate an orientation alert signal when the detected orientation falls outside of the acceptable range of orientations. The display screen may be configured to execute the orientation alert signal to provide a visual indication representative of the detected orientation falling outside the acceptable range. The may additionally include a speaker coupled to the main housing or the cable head. The speaker may be configured to execute the orientation alert signal to provide an audible indication representative of the detected orientation falling outside the acceptable range.

The display screen may be a touch screen.

According to another embodiment, there is provided a method of operating an automotive diagnostic kiosk. The method includes detecting, by a triggering sensor of the automotive diagnostic kiosk, at least a vehicle or a user within a predetermined range of the triggering sensor. The method additionally includes the step of autonomously generating a user guidance signal in response to receipt of the triggering signal, the user guidance signal being executable by the display screen to generate a visual alert on the display screen.

The method may additionally include the step of an orientation of the cable head relative to a direction of a gravitational force using a gyroscope and sending a signal to the processor representative of the detected orientation of the cable head. The method may additionally include the step of comparing the detected orientation of the cable head to an acceptable range of orientations and generating an orientation alert signal when the detected orientation falls outside of the acceptable range of orientations. The method may also include the step of providing a visual indication on the display screen representative of the detected orientation falling outside of the acceptable range. The method may additionally comprise the step of providing an audible indication via a speaker representative of the detected orientation falling outside of the acceptable range.

The method may further include the steps of receiving vehicle data from the vehicle via the cable head, and generating a status signal, executable by the display screen or a speaker, with the status signal being representative of the vehicle data received from the vehicle.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a schematic view of a kiosk-based automotive diagnostic system having autonomous functionality integrated therein;

FIG. 2 is a schematic view of a cable head forming part of the kiosk depicted in FIG. 1;

FIG. 3 is a flow chart illustrating a method of autonomously implementing audio and visual content based on detection of a user or a vehicle; and

FIG. 4 is a flow chart illustrating of a method of implementing vehicle-specific functionality associated with the kiosk.

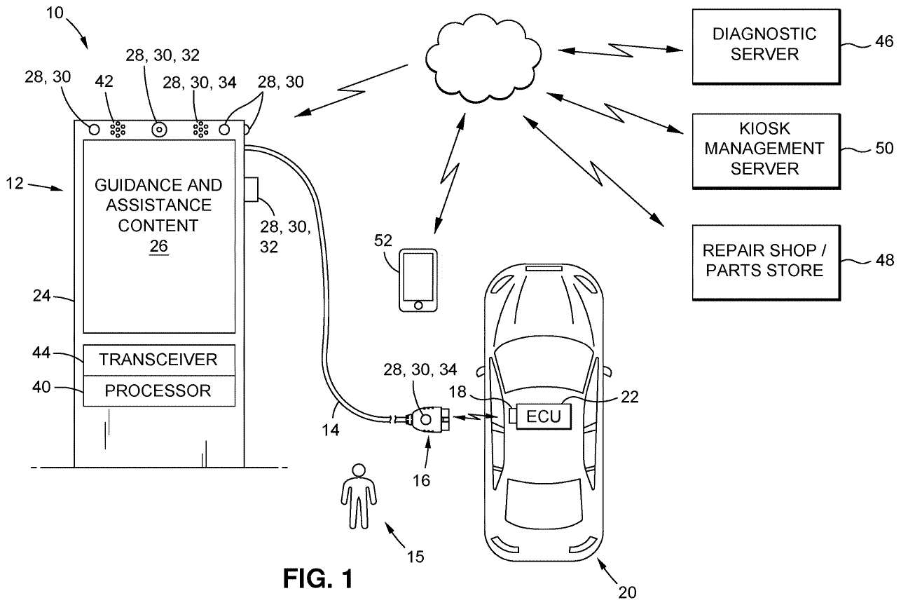

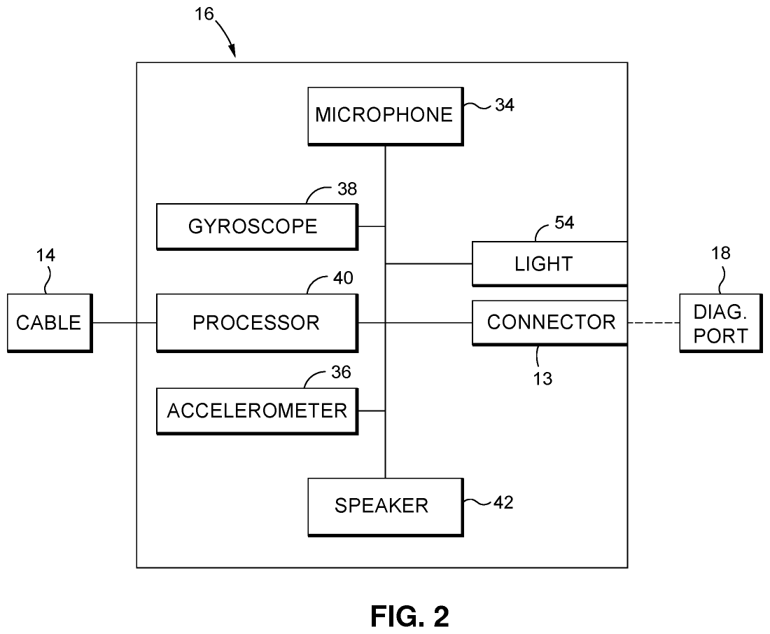

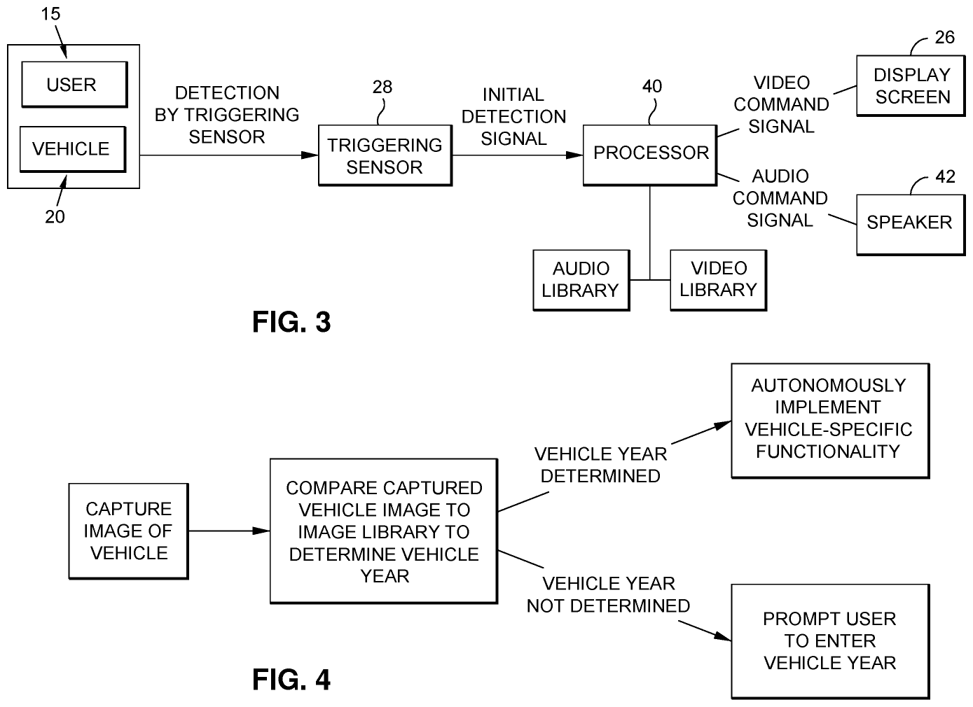

Common reference numerals are used throughout the drawings and the detailed description to indicate the same elements.

### DETAILED DESCRIPTION

The detailed description set forth below in connection with the appended drawings is intended as a description of certain embodiments of an automotive diagnostic kiosk having certain autonomous functionalities and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Referring now to the drawings, wherein the showings are for purposes of illustrating preferred embodiments of the present disclosure, and are not for purposes of limiting the same, there is depicted a kiosk-based automotive diagnostic system capable of detecting the presence of a vehicle and/or a user and implement certain functionalities of the kiosk in response to such detection. The autonomous capabilities of the kiosk may facilitate navigation of a kiosk user interface, retrieval of vehicle information, retrieval of customer information, and communication of vehicle diagnostic information. As such, the overall diagnostic process may proceed quicker and in a user-friendly manner.

The diagnostic system includes a kiosk 10 having a main unit 12, a cable 14, and a cable head 16 at an end of the cable 14 and configured to be plug connectable into a diagnostic port 18 on a vehicle 20 via a connector 13 on the cable head 16 to facilitate communication with an onboard computer (ECU) 22 or sensor. The main unit 12 includes a housing 24 and a display 26 connected to the housing 24. The housing 24 may be attached to the ground or an underlying support surface and may house electrical components associated with operation of the kiosk 10. It is contemplated that the kiosk 10 may be located in a parking lot/structure of a gas station, oil change facility, repair parts store, repair shop, shopping center, airport, etc. In some instances, the kiosk 10 may be associated with a dedicated parking spot, similar to parking spots associated with a charging station for electronic vehicles.

The display 26 may be connected to the housing 24 and may serve as a user interface which allows the user to enter information, make selections, as well as view information or data associated with the diagnostic process. The display 26 may be a touch screen display allowing the user to make selections through tactile gestures or contact with the display 26. As an alternative, the kiosk 10 may include a separate keypad or similar user input device, wherein the user may enter information. The display 26 may be positioned on the housing 24 at a location that is easy to see for the average adult user, e.g., the display 26 may be at eye level.

The kiosk 10 may additionally include one or more triggering sensors 28 that may detect proximity of certain objects or detect actions of certain objects to initiate autonomous one or more autonomous functions of the kiosk 10 or a related device (e.g., a diagnostic server). In one embodiment, the triggering sensors 28 may include proximity sensors 30 coupled to the kiosk housing 24 and/or the cable head 16, to detect the presence of the user 15 or a vehicle 20 adjacent the kiosk 10. The proximity sensor 30 may include a camera 32 or microphone 34 which may capture images or sounds of a person or vehicle 20 approaching the kiosk 10. The images or sounds may be used to determine proximity of the person or vehicle 20 relative to the kiosk 10. Captured images of the vehicle 20 may also be used to identify the vehicle 20 for purposes of implementing vehicle-specific functionality during use of the kiosk 10, such as obtaining vehicle-specific communication protocols, or identifying the specific location of the diagnostic port 18 for the vehicle 20 under test. The images may be analyzed by software to identify unique physical features of the vehicle 20, which may be compared to a library of stored vehicle features matched with year, make, model, engine (e.g., vehicle identification information) to identify the vehicle 20 under test.

It is also contemplated that the proximity sensor 30 may include a sensor which emits an electromagnetic field or a beam of electromagnetic radiation (e.g., infrared) and detects changes in the field or a return signal to determine proximity of an object. The proximity sensors 30 may also employ technology similar to the sensors commonly used on a vehicle to detect nearby vehicles. In this regard, it is contemplated that the proximity sensors 30 may employ any detection technology currently known, or later developed, by those skilled in the art.

The triggering sensors 28 may also include an accelerometer 36 and/or a gyroscope 38 located in the cable head 16. The accelerometer 36 may be cable of detecting movement of the cable head 16, such as retrieval of the cable head 16 from a holster on the kiosk housing 24, with the detected movement being used to autonomously initiate certain functions on the kiosk 10. Furthermore, the gyroscope 38 may be capable of detecting an orientation of the cable head 16 to ensure the cable head 16 is in a proper orientation for connecting the diagnostic port 18 on the vehicle 20. If the orientation is incorrect, an alert may be autonomously generated to alert the user of the incorrect orientation.

The kiosk 10 may include one or more processors 40 to implement the functionality of the kiosk 10. A processor 40 may be located at the kiosk housing 24, while another processor 40 may be located in the cable head 16. The processor(s) 40 may be in communication with the triggering sensor(s) 28, the display 26, a speaker, as well as onboard libraries of video and/or audio files.

The kiosk 10 may additionally include a transceiver 44 to facilitate kiosk communications with a remote device. In this regard the transceiver 44 may be configured to facilitate long-range communications to communicate with a remote diagnostic server 46, a parts/repair facility 48, a kiosk management server 50, etc. It is also contemplated that the transceiver 44 may be configured to facilitate short-range communications to communicate with a nearby electronic device, such as a smartphone 52 or other handheld electronic device associated with a user, or a vehicle's communication system.

With the basic architecture of the diagnostic kiosk 10 having been described above, the following discussion pertains to an exemplary use of the kiosk 10. A user may approach the kiosk 10 with their vehicle 20 and park adjacent the vehicle 20. In some instances, the kiosk 10 may be associated with a dedicated parking spot. The kiosk 10 may include a proximity sensor 30 and/or a microphone 34 which may detect the present and/or audio. The proximity sensor 30 may be aimed at the parking spot to detect occupancy of the parking spot. If vehicle occupancy is detected, or if an audio signal of the vehicle 20 pulling into the parking spot is detected, an initial detection signal may be sent by either the proximity sensor 30 and/or the microphone 34 to provide an indication of the detected presence of the vehicle 20.

The initial detection signal may be received by the processor 40, which may be programmed to autonomously send a command signal to the video screen to transition to an ON state, if the video screen was in an OFF state, and to display a welcome screen or home screen. The welcome screen or home screen may include an image or video providing an overview of the diagnostic capabilities offered by the kiosk 10, as well as an explanation which highlights the user-friendly nature of the kiosk 10, particularly the interactive nature of the kiosk 10, as well as possible step-by-step video and audio guidance provided by the kiosk 10.

The generation of the initial detection signal may also autonomously trigger a camera 32 to capture an image or video of the vehicle 20 for purposes of trying to identify the vehicle under test for implementing vehicle specific features of the kiosk 10. The image captured by the kiosk 10 may be communicated to the processor 40 for analysis locally on the kiosk 10, or for upload to a remote server for analysis. The analysis may utilize software capable of extracting identifying features on the vehicle 20 and comparing those features with a library of stored features associated with known vehicles. For instance, the vehicle grill may be unique to a specific year, make and model of the vehicle 20 and may be used to identify the vehicle 20. Any portion(s) of the vehicle 20 may be used when analyzing the image to determine the identity of the vehicle 20. If a match is made and the likely identity of the vehicle 20 is determined, the likely identity may be sent to the kiosk 10 and/or saved at a remote location for later use. In either case, the likely identity of the vehicle 20 may be associated with an identifier, such as an electronic ID of the kiosk 10, as well as the date and time the image of the vehicle 20 was captured, in order to retrieve or reference the likely identity of the vehicle 20 at a later time.

After the vehicle 20 is parked, the user may exit the vehicle 20 and approach the kiosk 10. In certain embodiments, the kiosk 10 may be capable of detecting an identifying wireless signal either from the vehicle 20, such as a signal associated with a local wireless communication network (e.g., Bluetooth™) on the vehicle 20, or a local wireless signal emitted by a handheld communication device associated with the user, such as a Bluetooth™ signal emitted by a user's smartphone. The identifying wireless signal may be associated with a unique ID, that may have been identified, stored, and correlated to the vehicle 20 under test during a previous visit to a kiosk 10, or a related kiosk/location. Thus, when the vehicle 20 and/or user are within a detectable range of the kiosk 10, the identifying wireless signal may be detected, and upon detection, the vehicle identification information of the vehicle 20 under test may be autonomously identified due to its correlation to the identifying wireless signal.

If the vehicle identification information cannot be autonomously determined either because the user has not previously visited a kiosk 10, or the kiosk 10 cannot autonomously determine the vehicle identifying information, as described above, the proximity sensor 30, camera 32, or microphone 34 may detect the approaching user and generate a user detection signal, which may be communicated to the processer. In response to receiving the user detection signal, the processor 40 may autonomously send a command signal to the display screen 26 and speaker 42 to play a welcome video with corresponding audio, or a to display a welcome screen with a button that invites the user to enter initial information. The initial information requested may be as minimal as asking for the year of the vehicle 20, although the initial requested information may also include the make, model and engine of the vehicle 20, as well as customer identification information, such as name, email, phone number, address, billing information, diagnostic preferences, etc.

Once the year of the vehicle 20 is entered or otherwise determined, the year of the vehicle 20 may be used to determine if electronic vehicle identification information can be extracted or retrieved from the vehicle 20. Older vehicles may not have electronic vehicle identification accessible from their onboard computer, while newer vehicles may be capable of providing electronic vehicle identification information. Vehicle year information may be entered by the user and received at the kiosk 10. The processor 40 may analyze the entered vehicle year information and determine if the vehicle 20 is capable of providing electronic vehicle identification information. If it is determined that the vehicle 20 cannot provide that information, the processor 40 may generate a signal which results in a prompt being depicted on the display screen 26 for the user to enter the vehicle identification number (VIN).

After the year of the vehicle 20 has been determined, one or more vehicle specific features associated with operation of the kiosk 10 may be identified and implemented. For instance, any vehicle-specific diagnostic communication protocols may be identified and readied for use in communicating with the vehicle 20. Furthermore, any vehicle specific instructions, schematics, videos, images, audio, etc., may be identified and readied for use.

The user may be prompted, via an instructional video, image, and/or corresponding audio, to connect the cable head 16 to the diagnostic port 18 on the vehicle 20. The prompting may be vehicle-specific, with videos, image, or audio that is unique to the vehicle 20 under test. The user may follow the instructions and grab the cable head 16 for connection to the vehicle 20.

The kiosk 10 may be capable of detecting the user grabbing the cable head 16. For instance, the cable head 16 may rest on a holster connected to the main housing 24, such that removal of the cable head 16 from the holster may be detected by a switch, which may send a signal to the processor 40 indicating the detected removal of the cable head 16 from the holster. The cable head 16 may also include an accelerometer 36 or gyroscope 38 located within the cable head 16 capable of detecting movement and orientation of the cable head 16. If the accelerometer 36 and/or gyroscope 38 detect removal of the cable head 16 from the holster, a removal signal may be sent to the processor 40.

In response to receiving the removal signal, the processor 40 may send a command signal to a light element on the cable head 16 to illuminate the light element to provide illumination to the user when trying to connect the cable head 16 to the diagnostic port 18 on the vehicle 20. In this regard, the diagnostic port 18 is commonly located below the steering wheel, and thus, may be in a dark location.

The gyroscope 38 may also be capable of detecting whether the cable head 16 is in a proper orientation for connection with the diagnostic port 18. If an improper orientation is detected, the gyroscope 38 may send a signal to the processor 40, which may in turn, send a command signal to the speaker to provide an audible alert to the user to correct the orientation of cable head 16 to facilitate plug connection with the diagnostic port 18.

Once the cable head 16 is connected to the diagnostic port 18 on the vehicle 20, the processor 40 may receive a signal from the vehicle 20 indicative of a proper connection. In response to receipt of that signal, the processor 40 may send a command signal to the speaker to emit an audible alert notifying the user that a successful connection has been made.

The processor 40 may also send a vehicle data request signal to the vehicle 20 autonomously in response to receipt of the signal from the vehicle 20 that is indicative of a proper connection. The vehicle data request signal may include a request for vehicle identification information, as well as vehicle diagnostic data, including diagnostic trouble codes (DTCs), live data, sensor data, or other data that may be available from the vehicle 20.

As the cable head 16 receives data from the vehicle 20, the kiosk 10 may provide an audible and/or visual alert to the user via the speaker and/or the display screen 26. The alert may simply notify the user that data is being retrieved from the vehicle 20. In some instances, the visual alert may include a graph the provides an indication as to how much data has been retrieved, and how much remains to be retrieved.

When all of the data is retrieved, a signal (audible and/or visual) may be generated by the kiosk 10 to alert the user that all of the data has been retrieved and that the cable head 16 can be disconnected from the vehicle 20 and replaced back on its holster.

The vehicle data received from the vehicle 20 may be uploaded to a remote diagnostic server, via the transceiver 44 in the kiosk housing 24, for diagnostic analysis. The remote diagnostic server may be capable of identifying a most likely fix based on an analysis of the data received from the vehicle 20. The diagnostic server may also be capable of determining a diagnostic urgency based on an evaluation of the data received from the vehicle 20. For instance, the diagnostic urgency may be determined to be high urgency, low urgency, or no urgency.

For more information related to the analysis of diagnostic data at the remote server, please refer to U.S. Pat. No. 6,807,469, entitled AUTO DIAGNOSTIC METHOD AND DEVICE, U.S. Pat. No. 6,925,368, entitled AUTO DIAGNOSTIC METHOD AND DEVICE, U.S. Pat. No. 7,620,484, entitled AUTOMOTIVE MOBILE DIAGNOSTICS, U.S. Pat. No. 8,019,503, entitled AUTOMOTIVE DIAGNOSTIC AND REMEDIAL PROCESS, U.S. Pat. No. 8,370,018, entitled AUTOMOTIVE DIAGNOSTIC PROCESS, U.S. Pat. No. 8,909,416, entitled HANDHELD SCAN TOOL WITH FIXED SOLUTION CAPABILITY, U.S. Pat. No. 9,026,400, entitled DIAGNOSTIC PROCESS FOR HOME ELECTRONIC DEVICES, U.S. Pat. No. 9,177,428, entitled PREDICTIVE DIAGNOSTIC METHOD, U.S. Pat. No. 9,646,432, entitled HAND HELD DATA RETRIEVAL DEVICE WITH FIXED SOLUTION CAPABILITY, U.S. Pat. No. 10,643,403, entitled PREDICTIVE DIAGNOSTIC METHOD AND SYSTEM, U.S. Patent Application Pub. No. 2013/0297143, entitled METHOD OF PROCESSING VEHICLE DIAGNOSTIC DATA, U.S. Patent Application Pub. No. 2019/0304208, entitled SYSTEM AND METHOD FOR PROACTIVE VEHICLE DIAGNOSIS AND OPERATIONAL ALERT, and U.S. Patent Application Pub. No. 2019/0304213, entitled SYSTEM AND METHOD FOR PROACTIVE VEHICLE DIAGNOSIS AND OPERATIONAL ALERT, the entire contents of each of which is expressly incorporated herein by reference.

After the data has been uploaded, the processor 40 may generate a prompt on the display screen 26 for the user to enter an electronic address (e.g., email address or smartphone number) for a diagnostic report to be sent. The diagnostic report may include a detailed assessment of the diagnostic analysis, including a listing of any retrieved DTCs, any retrieved data that was believed to be outside of an acceptable range, a most likely fix, a possible repair solution, a possible replacement part(s), etc. A summary of the diagnostic assessment may be presented on the kiosk display screen 26. For instance, the summary may include the most likely fix, and/or a diagnostic urgency assessment.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. An interactive automotive diagnostic kiosk comprising:
a main housing;
a processor in the main housing;
a display screen coupled to the main housing and in operative communication with the processor;
a cable head in operative communication with the processor, the cable head being configured to be plug connectable to a diagnostic port on a vehicle to facilitate data communication therebetween; and
a triggering sensor configured to detect at least a vehicle or a user and send a triggering signal to the processor in response to such detection;
the processor being configured to autonomously generate a user guidance signal, executable by the display screen, to generate a visual alert on the display screen in response to receipt of the triggering signal.

2. The kiosk recited in claim 1, wherein the triggering sensor is a proximity sensor coupled to the main housing and capable of detecting the presence of the vehicle or the user within a prescribed range relative to the proximity sensor.

3. The kiosk recited in claim 2, wherein the proximity sensor is an infrared sensor.

4. The kiosk recited in claim 2, wherein the prescribed range is less than 25 feet.

5. The kiosk recited in claim 1, wherein the triggering sensor is a camera coupled to the main housing and capable of capturing an image of the vehicle or the user.

6. The kiosk recited in claim 1, wherein the triggering sensor is a microphone coupled to the main housing or the cable head and configured to detect an audible sound associated with the vehicle or the user arriving within a prescribed range relative to the microphone.

7. The kiosk recited in claim 1, further comprising a gyroscope coupled to the cable head, the gyroscope being configured to detect an orientation of the cable head relative to a direction of a gravitational force and send a signal to the processor representative of the detected orientation of the cable head.

8. The kiosk recited in claim 7, wherein the processor is configured to compare the detected orientation of the cable head to an acceptable range of orientations and generate an orientation alert signal when the detected orientation falls outside of the acceptable range of orientations.

9. The kiosk recited in claim 8, wherein the display screen is configured to execute the orientation alert signal to provide a visual indication representative of the detected orientation falling outside the acceptable range.

10. The kiosk recited in claim 8, further comprising a speaker coupled to the main housing or the cable head, the speaker being configured to execute the orientation alert signal to provide an audible indication representative of the detected orientation falling outside the acceptable range.

11. The kiosk recited in claim 1, wherein the display screen is a touch screen.

12. A method of operating an automotive diagnostic kiosk, the method comprising the steps of:
detecting, by a triggering sensor of the automotive diagnostic kiosk, at least a vehicle or a user within a predetermined range of the triggering sensor, the automotive diagnostic kiosk having:
a main housing;
a processor in the main housing;
a display screen coupled to the main housing and in operative communication with the processor;
a cable head in operative communication with the processor, the cable head being configured to be plug connectable to a diagnostic port on a vehicle to facilitate data communication therebetween; and
the triggering sensor; and
autonomously generating a user guidance signal in response to receipt of the triggering signal, the user guidance signal being executable by the display screen to generate a visual alert on the display screen.

13. The method recited in claim 12, wherein triggering sensor in the detecting step is a proximity sensor capable of detecting the presence of the vehicle or the user within a prescribed range relative to the proximity sensor.

14. The method recited in claim 12, wherein the triggering sensor in the detecting step is a camera coupled to the main housing and capable of capturing an image of the vehicle or the user.

15. The method recited in claim 12, wherein the triggering sensor in the detecting step is a microphone coupled to the main housing or the cable head and configured to detect an audible sound associated with the vehicle or the user arriving within a prescribed range relative to the microphone.

16. The method recited in claim 12, further comprising the step of detecting an orientation of the cable head relative to a direction of a gravitational force using a gyroscope and sending a signal to the processor representative of the detected orientation of the cable head.

17. The method recited in claim 16, further comprising the step of comparing the detected orientation of the cable head to an acceptable range of orientations and generating an orientation alert signal when the detected orientation falls outside of the acceptable range of orientations.

18. The method recited in claim 17, further comprising the step of providing a visual indication on the display screen representative of the detected orientation falling outside of the acceptable range.

19. The method recited in claim 17, further comprising the step of providing an audible indication via a speaker representative of the detected orientation falling outside of the acceptable range.

20. The method recited in claim 12, further comprising the steps of:
receiving vehicle data from the vehicle via the cable head; and
generating a status signal, executable by the display screen or a speaker, the status signal being representative of the vehicle data received from the vehicle.
